(19) United States
(12) Patent Application Publication
(10) Pub. No.: US 2002/0160352 A1
(43) Pub. Date: Oct. 31, 2002

(54) Dry erase and tack display board having no frame

(76) Inventor: Steve Beno, Skokie, IL (US)

Correspondence Address: Martin Faier, Faier & Faier P.C., 566 W. Adams St. #600, Chicago, IL, 60661, US

(21) Appl. No.: 09/799,830

(22) Filed: Mar. 6, 2001

(51) Int. Cl. B43L 1/00

(52) U.S. Cl. 434/408

(57) ABSTRACT

Tackable and markable dry erase display boards which have no frame and which may be die cut from moldable foam material capable of receiving and holding mounting pins and substantially closing after a pin is withdrawn. Such boards are light weight and can be mounted on substantially any desired surface without hardware or tools, and can be fabricated in substantially any desired color. The boards may have convenient means for holding accessories such as an eraser or marking implement.

This invention relates to boards which may be used to display removably tacked on and written materials, but which have no frame for containing the tackable and writable surfaces of the board.

### SUMMARY AND BACKGROUND OF THE INVENTION

Dry erase boards and tackable display boards are old in the art. These boards usually may have a tackable surface, such as cork or fiber. and a markable surface, such as melamine, porcelain coated paper, metal or film. The tackable surface preferably permits a note or display to be attached to the board by a push pin or thumb tack, and preferably the pin or tack may be removed to permit mounting of another note or display. Preferably the markable surface may be erased with an eraser or wiped with a cloth, to permit another marking to be made on the markable surface.

Examples of such dry erase boards and tackable display boards may be found in several prior art patents, such as

| | |
|---|---|
| Boone et al U.S. Pat. No. 5,527,568 | Lassoff U.S. Pat. No. 5,655,323 |
| Davis et al U.S. Pat. No. 5,658,635 | Davis et al U.S. Pat. No. 5,928,756 |
| Bianco U.S. Pat. No. 5,948,498 | Davis et al U.S. Pat. No. 5,976,663 |

and others

However, all of these patents require a frame or backing and in no known patent or prior art disclosure can a combination board be mounted without a frame or backing. Additionally, the presence of the frame or backing inhibits the decorative use of more than one assembled shaped boards, for example, where one board is circular shaped and fits into another board which is of a mating crescent shape.

### SUMMARY OF THE PRESENT INVENTION

Combination boards embodying the present invention can have both a tackable surface and a markable surface, and the board may be die cut in any desired shape permitting one or more boards to be die cut and assembled into any decorative form, such as free forms, geometric forms or circular forms, or a combination of such forms, without the use of special backing, frames or the like. These forms permit the fabrication of such combination boards without extra manufacturing steps or special jigs or machines to fabricating and mount and secure frames or backing.

Additionally, a board embodying the present invention may be fabricated with an eraser or pen holder and the erasable member may be mounted at almost any position, permitting great versatility for such a board. Preferably the board is fabricated from a moldable foam material, which can be die cut to any desirable shape but is relatively light in weight and thick enough to hold a push pin. The moldable material must also be rubber-like and capable of receiving multiple pin pricks, so that it may be used many times without leaving formed pin holes. A preferred material is ethyl vinyl acetate (or EVA) foam, which is capable of holding pins, and which has the ability for the pin hole to substantially close after a pin is withdrawn.

The preferred EVA foam also may be fabricated in almost any color, without over coatings, coverings, or any extra coloring steps. This feature permits these boards to be decorative or color coordinated in special environments.

A board embodying the present invention may have mounting means secured to it. Such mounting means may consist of magnetic strips, where the board is to be mounted on a metal partition wall or on a refrigerator, or double sided pressure sensitive tape strips, which permit the board to be mounted on most surfaces. Mounting may be accomplished without the use of any hardware or tools.

The markable surface may consist of a thin panel of any shape or size which is glued or otherwise secured to the EVA foam. This panel may consist of a sheet of thin laminate plastic having a film surface which can be written upon. The surface may be wiped clean without any cleaners or moisture applied, and reused. Preferably, a writing implement, such as a Sanford Expo marker, or the like, may be used. A preferred material for the markable surface of the board is dry erase styrene.

### OBJECTS AND ADVANTAGES OF THE INVENTION

It is the object of the present invention to provide a dry erase and tack display board having no frame of the character referred to.

Another object is to provide a combination tackable and markable display board which has no frame or special backing.

Another object is to provide such a combination tackable and markable display board which can be die cut and assembled into substantially any convenient decorative form.

Another object is to provide such a die-cutable tackable and markable display board which can be combined and associated with another board of similar structure.

Another object is to provide such a frame-less combination tackable and markable display board which has a body structure composed of moldable material, such as ethyl vinyl acetate foam.

Another object is to provide such a frame-less combination tackable foam and markable display board which has convenient means for holding accessories such as an eraser or marking implement.

Another object is to provide a frame-less combination tackable foam and markable display board which is capable of receiving and holding mounting pins and which has the ability for the foam to substantially close after a pin is withdrawn.

Another object is to provide such a frame-less combination tackable foam and markable display board which can be fabricated from substantially any desired color.

Another object is to provide such a frame-less combination tackable foam and markable display board which is relatively light in weight and can be mounted on substantially any desired surface without hardware or tools.

Another object is to provide such a frame-less combination tackable foam and markable display board which has an erasable surface which may be wiped clean without any cleaners or applied moisture and reused.

Another object is to provide such a frame-less combination tackable foam and markable display board which is simple and easy to fabricate and which is easy to use and re-use.

These and other objects and advantages of the invention will become more apparent as this description proceeds, taken in conjunction with the accompanying drawings.

### BRIEF DESCRIPTION OF THE DRAWINGS

In the drawings:

FIG. 1 is a perspective view of an exemplary dry erase and tack display board having no frame embodying the present invention.

FIG. 2 is an enlarged detail sectional view of a part of such a board showing the means for securing an accessory, such as a writing implement onto the board, taken on the line 2-2 of FIG. 1.

FIG. 3 is an enlarged sectional view of the board which also shows the means for securing an eraser, taken on line 3-3 of FIG. 1.

FIG. 4 is a front plan view of modified combination round and crescent boards embodying the invention which may be fit together for decorative and special purposes.

FIG. 5 is a side elevational view of the combination boards shown in FIG. 4.

FIG. 6 is an enlarged sectional view of a part of the board shown in FIG. 4, taken on line 6-6—of FIG. 4.

### DESCRIPTION OF THE PREFERRED EMBODIMENTS

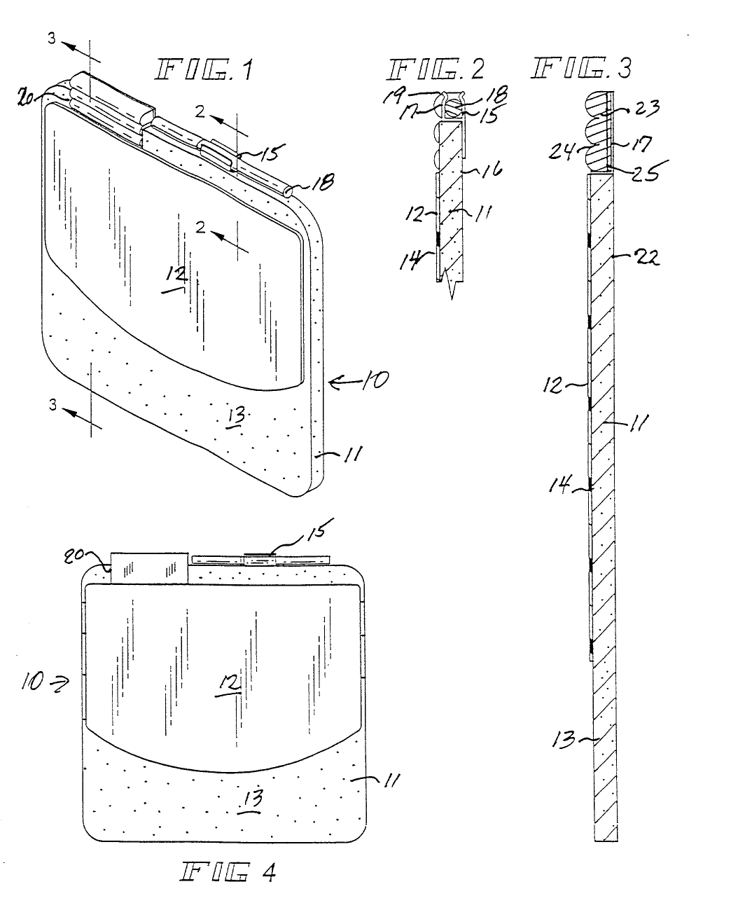

With reference to the accompanying drawings and particularly to FIGS. 1-4, a display board 10 embodying the present invention preferably has a body 11 of molded foam material, which may be die cut from EVA foam or similar material which is light in weight an had the ability to receive and hold push pins or thumb tacks so that the pins or tacks may be removed and the holes will substantially close, to permit later mounting of other materials onto the board. Secured onto the face side 13 of the foam body 11 is a sheet 12 of markable material, such a dry erase styrene, which has a surface 14 which may be written or marked upon and which may be erased. This sheet 12 is preferably appropriately secured to the body 11 by glue or cement.

A clip 15 may be glued to the rear side 16 of the foam body 11 and may have a channel 17 for receiving therein a pen 18 or other marking implement. This channel 17 may have snap engaging flexible legs 19 to stow the pen 18 in a desired position when not in use. A portion 20 of the foam body 11 may be cut away, and a small panel 21 may be secured, as by glue, to the rear side 22 of the board body for holding an eraser 23 in the cut away portion 20, and this eraser 23 may have a series of parallel ribs 24, facilitating holding the same by hand, and a dry absorbent erasing surface 25, such as felt, for use as an eraser to wipe clean marking placed on the surface 14 of the dry erase sheet 12.

Mounting of the board 10 may be accomplished by any conventional means (not shown) such as double sides pressure sensitive tape or pressure sensitive magnetic tape or other means.

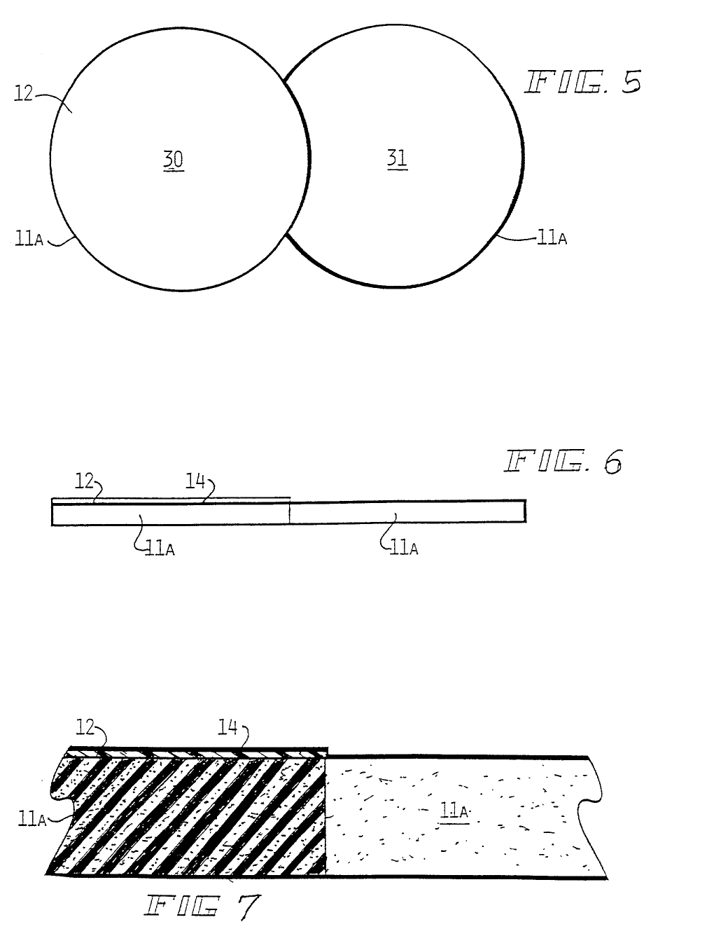

As shown in FIGS. 5-7, foam bodies 1a may be die cut into any shape, such as a circle 30 and a crescent 31. One or both of these foam bodies 11a may comprise a sheet 12 having a markable surface 14. The dry cut foam bodies 11a may be nested together as shown, for decorative or other purposes. Similar cooperative foam sheets may be used, such as geometric or special shapes, utilizing the same foam tackboard and erasable materials.

While preferred embodiments of the invention have been shown and described, it is not desired that the invention should be limited to the structure or element shown, except as limited by the appended claims.

I claim:

1. A tackable and markable dry erase board assembly for displaying information written thereon and tacked to a surface of said board,
said board having no frame or backing,
said board comprising
a body of moldable foam material having a mounting surface adapted to receive and hold a mounting tack in a hole formed in said body by said tack, said form material being adapted to substantially close said hole after said tack is withdrawn, and.
a panel having a writing surface adapted for erasing when written upon,
said panel being secured to a portion of said moldable foam body mounting surface.

2. The board recited in claim 1, wherein said moldable foam material comprises ethyl vinyl acetate foam.

3. The board recited in claim 1, wherein said body may be formed by die cutting a sheet of moldable foam material.

4. The board recited in claim 1, wherein said body is elastic.

5. The board recited in claim 1, wherein said panel comprises a sheet of dry erase styrene.

6. The board recited in claim 1, wherein said panel is glued to said foam body mounting surface.

7. The board recited in claim 1, wherein said assembly is light in weight and said body has a board securing surface opposed to said mounting surface.

8. The board recited in claim 7, wherein said board securing surface has means for mounting said assembly on a wall.

9. The board recited in claim 8, wherein said means comprises magnetic tape secured to said board securing surface.

10. The board recited in claim 8, wherein said means comprises double sided pressure sensitive tape, one side of which is secured to said board securing surface.

11. The board recited in claim 1, wherein said body has a recess and an eraser is removably secured in said recess.

12. The board recited in claim 1, wherein a clip is engaged over an edge of said body and a writing implement is removably secured in said clip.

13. The board recited in claim 1, wherein a second board has a body of like foam material formed to cooperatively receive said said board assembly.

14. The board recited in claim 13, wherein said second board and board assembly are nested together to form a unitary display.

15. The board assembly recited in claim 13, wherein said second board has an erasable writing surface secured to its body of foam material.

16. The board recited in claim 1, wherein said a portion of said mounting surface is free of said panel.

17. The board recited in claim 1, wherein said foam material may be selectively colored to substantially any desired color.
